(19) United States
(12) Patent Application Publication
(10) Pub. No.: US 2003/0138696 A1
(43) Pub. Date: Jul. 24, 2003

(54) High voltage lithium insertion compound usable as cathode active material for a rechargeable lithium electrochemical cell

(75) Inventors: Jean-Paul Peres, Merignac (FR); Andre Lecerf, Pace (FR); Clemence Siret, Bruges (FR); Jean-Pierre Boeuve, Montussan (FR); Claudette Audry, Bruges (FR); Philippe Biensan, Carignan de Bordeaux (FR)

Correspondence Address: SUGHRUE MION, PLLC, Suite 800, 2100 Pennsylvania Avenue, N.W., Washington, DC, 20037-3213, US

(73) Assignee: ALCATEL

(21) Appl. No.: 10/289,343

(22) Filed: Nov. 7, 2002

(30) Foreign Application Priority Data
Nov. 8, 2001 (FR) 01 14 459

(51) Int. Cl. H01M 4/50; C01G 45/12; C01G 23/04; C01G 51/04; C01G 39/02

(52) U.S. Cl. 429/231.1; 429/231.3; 429/231.5; 429/224; 423/599; 423/598; 423/594.1

(57) ABSTRACT

The present invention provides a lithium insertion compound suitable for operating at a voltage greater than 4.5 V relative to Li/Li⁺, derived by substituting spinel structure lithium manganese dioxide, the compound being characterized in that its formula is:

LiMn_{2-(x+y)}MₓM′_{y}O₄

in which 0<x, 0<y, x+y>0.50, M is Co, and M′ is selected from Ti and Mo. The invention also provides a method of manufacturing an insertion compound according to any preceding claim, from a spinel structure intermediate compound of general formula Liᵣ(E)₃O₄ in which r<1 and E designates the set of cations to be introduced into the final material. This method produces a lithium insertion compound suitable for operating at a voltage higher than 4.5 V relative to Li/Li⁺, derived by substituting spinel structure lithium manganese dioxide, the compound being characterized in that its formula is:

LiMn_{2-(x+y)}MₓM′_{y}O₄

in which 0<x, 0<y, x+y>0.50, M is Co or Ni, and M′ is selected from Ti, Al, Co, and Mo.

The present invention relates to a lithium insertion compound for use as active material in the positive electrode of a rechargeable electrochemical cell, the compound being particularly suitable for operating at high voltage, and in particular at a voltage higher than 4.5 volts (V) relative to Li/Li⁺.

The invention also extends to the method of manufacturing the compound, to the positive electrode containing it, and to the rechargeable electrochemical cell including said electrode.

The electrodes of lithium electrochemical cells contain an electrochemically active material which constitutes a host structure in which lithium cations become inserted and deinserted during cycling. Two different insertion compounds are used in Li-ion type cells: one for the anode; and the other for the cathode. In the positive electrode or “cathode”, it is common practice for the active material to be constituted by lithium oxides of transition metals having the general formula LiₓM_{y}Oₜ, where M is usually Mn, Ni, or Co. Nickel and cobalt oxides present the drawback of being much more expensive than manganese oxide, and furthermore their production is geographically restricted to high risk zones.

Among cathode active materials, materials based on lithium manganese dioxide have been the subject of numerous tests. Some of them have turned out to be poorly rechargeable or not rechargeable. For most materials of spinel structure, the specific capacity of a cell decreases rapidly after a few cycles. To improve the stability of such compounds, work has been directed towards modifying stoichiometry or towards introducing a metal cation substituting a fraction of the manganese.

For the electrochemical cell to be capable of supplying high energy density per unit volume, it must be capable of operating at a voltage that is sufficiently high. Unfortunately, certain materials which have turned out to be of interest as active material for an electrode have operating voltages that are too low. Electrodes containing them therefore need to be associated with opposite-polarity electrodes having operating voltages that are greater than those of known electrodes. Researchers have thus investigated active materials which are capable of supplying the major fraction of their working capacity at high voltage, and in particular at a voltage greater than 4.5 V relative to Li/Li⁺.

U.S. Pat. No. 5 962 166 proposes insertion compounds satisfying the general equation: LiM_{y}^{II}M_{z}^{III}Mnₗ^{III}Mn_{q}^{IV}O₄ in which 0<y+z≦0.5 and y+z+l+q=2, and M represents one or more metals or transition metals. Those compounds comprise at least two components each possessing two valency levels. They may also satisfy the formula LiM_{y}Cu_{0.5-y}Mn_{1.5}O₄ with 0≦y≦0.49. By way of example, specific mention is made of the compound having the formula LiNiₓCu_{(0.5-x})Mn_{1.5}O₄ where 0.15≦x ≦0.49. Although those compounds are stable at high potential, they possess low capacities.

Another solution is provided by French patent No. 2 738 673 which describes a lithium insertion compound of structure similar to a spinel having the general formula Li_{x+y}M_{z}Mn_{2-y-z}O₄ in which M is a transition metal and 0≦x<1, 0≦y<0.33, and 0<z<about 1. Those compounds have large useful capacity above 4.5 V relative to lithium when M is Ni or Cr. Specific examples given are the following compounds: LiMn_{1.5}Ni_{0.5}O₄, LiMn_{1.6}Ni_{0.4}O₄, Li_{1.1}Ni_{0.4}O₄, and LiMn_{1.5}Cr_{0.5}O₄, Nevertheless, the recharge capacity is greater than the capacity discharged for the following compounds LiMn_{1.5}Ni_{0.5}O₄, LiMn_{1.6}Ni_{0.4}O₄, and LiMn_{1.5}Cr_{0.5}O₄, which might be indicative of degradation of the cathode material.

An object of the present invention is to propose an electrochemically active material operating at a voltage greater than 4.5 V relative to Li/Li⁺, and presenting both high capacity and good cycling stability.

Lithium insertion compounds suitable for operating at a voltage greater than 4.5 V relative to Li/Li⁺are, in particular, those derived by substituting spinel structure lithium manganese dioxide. These insertion compounds have a normal spinel structure and have the formula:

LiMn_{2-(x+y)}MₓM′_{y}O₄

in which 0<x, 0<y, x+y>0.50, M is Ni or Co, and M′ is selected from Ti, Al, Co, and Mo.

The present invention provides lithium insertion compound suitable for operating at a voltage greater than 4.5 V relative to Li/Li⁺, derived by substituting spinel structure lithium manganese dioxide, the compound being characterized in that its formula is:

LiMn_{2-(x+y)}MₓM′_{y}O₄

in which 0<x, 0<y, x+y>0.50, M is Co, and M′ is selected from Ti and Mo.

Compounds for which x+y≦0.50 and that do not form part of the present invention have the drawback of presenting lower reversible capacity, with lithium insertion and deinsertion being coupled to a change in the degree of oxidation of the M ion.

Lithium manganese oxides of general formula LiMn₂O₄ have a spinal type crystallographic structure. A spinel is said to be “normal” when it is constituted by a face centered cubic lattice of O²⁻¹ ions in which the Li⁺cation occupies ⅛th of the tetrahedral sites, while the Mn³⁺/Mn⁴⁺ cations are inserted in half of the octahedral sites. With inverse spinels, all of the Li⁺ions are situated at octahedral sites and half the Mn³⁺/Mn⁴⁺ cations then occupy tetrahedral sites; they are thus shared between the octahedral sites and the tetrahedral sites. The insertion compounds of the invention are made by doping a spinel structure LiMn₂O₄ oxide with a plurality of elements to the detriment of the manganese. All of the dopant elements substituting the Mn³⁺/Mn⁴⁺ cations are thus to be found at octahedral sites in a normal spinel structure.

In a variant of the invention, the compound has the formula: LiMn_{1.0-y}Co_{1.0}M′_{y}O₄ in which 0<y and M′ is selected from Ti and Mo.

In a first embodiment of the invention, M′ is Ti and the compound has the formula: LiMn_{2-(x+y)}CoₓTi_{y}O₄ in which 0<x, 0<y, x+y>0.50.

In a variant, the compound has the formula: LiMn_{1.0-y}Co_{1.0}Ti_{y}O₄ in which 0<y.

In a second embodiment of the invention, M′ is Mo and the compound has the formula: LiMn_{2-(x+y)}CoₓMo_{y}O₄ in which 0<x, 0<y, x+y>0.50.

In a variant, the compound has the formula: LiMn_{1.0-y}Co_{1.0}Mo_{y}O₄ in which 0<y.

The insertion compounds of the invention present high reversible capacities lying in the range 100 milliampere hours per gram (mAh/g) to 140 mAh/g of active material. More than 80% of this capacity is obtained at a voltage lying in the range 4.5 V to 5.3 V relative to Li/Li⁺, and the reversible capacity obtained is stable over several cycles at ambient temperature. In addition, using compounds of the invention in the positive electrode of a rechargeable cell reveals a decrease in the irreversible portion of the capacity of the first electrochemical cycle. Furthermore, since these materials are very stable at high potential, there is no significant drift in the charge/discharge cycling curves, and thus no parasitic current that might represent reactions between the active material and the electrolyte.

The invention also provides a method of manufacturing such an insertion compound, the method comprising a step of preparing an intermediate compound having no or very little lithium and of spinel structure with the general formula Liᵣ(E)₃O₄ in which r<1 and E designates the set of cations to be introduced into the final material, i.e. manganese and the dopant represented by M in the general formula. The structure of the intermediate compound Liᵣ(E)₃O₄ is a spinel structure or is derived from spinel structure by distortion. The use of the intermediate compound makes it easier to insert a plurality of dopants into the spinel structure of the insertion compound. The intermediate compound Liᵣ(E)₃O₄ or (E)₃O₄ may be synthesized by a known solid state method optionally using an initial precipitation step, e.g. precipitating oxalates or of hydroxides. The intermediate compound is prepared at high temperature.

In order to prepare insertion compounds of the invention from an intermediate compound, the manufacturing method comprises a reaction of diffusing lithium into said intermediate compound coupled with a reaction of oxidizing said intermediate compound. Various lithiating agents can be used such as a carbonate, a hydroxide, or a nitrate. Oxidation can be implemented using, for example, oxygen, air, an oxide of nitrogen, or the nitrate ion. The reactions are caused to take place by heat treatment at a temperature lying in the range 600° C. to 900° C. and at atmospheric pressure. For example, with Li₂CO₃ as the lithiating agent and oxygen as the oxidizer, the reaction is written as follows:

6Li₂CO₃+5O₂+8(E)₃O₄→12LiE₂O₄+6CO₂

With LiNO₃ acting both as the lithiating agent and as the oxidizer, the reaction is written as follows:

3LiCO₃+2(E)₃O₄→3LiE₃O₄+2NO₂+NO

The uniformity of the resulting material is excellent, which makes it easier to control grain size and specific surface area. The insertion compound obtained by the method of the invention is in the form of a powder made up of black particles, most of them being substantially in the form of parallelepipeds, of size φ such that 1 micrometer (μm) <φ<30 μm. It is preferable to use particles of size such that 2 μm≦φ≦13 μm with a mean size φₘₑₐₙ=7 μm. These particles are constituted by agglomerated crystallites of size smaller than 1 μm.

This method presents the advantage of making synthesis easy since the insertion compound is obtained in a single step from the intermediate compound. Another advantage comes from all of the doping elements being introduced simultaneously. This method makes it possible to incorporate a wide variety of elements into the intermediate compound (E)₃O₄ at high temperature without concern for the volatility of lithium. It has been found that doping with a plurality of elements makes it easier to synthesize the material compared with a compound doped using a single element. In particular, if the dopants are nickel or titanium, synthesis is made easier and no residual “NiO” is formed. Titanium insertion in particular is very difficult, and only synthesis by the method of the invention makes it possible to insert titanium properly in the spinel structure. Furthermore, the presence of titanium makes it possible to obtain a phase that is more pure. A compound of the LiMn₁₋ₓNiₓO₄ type, e.g. LiMn_{1.50}Ni_{0.50}O₄ always contains a residual cubic phase of the “NiO” type, whereas the single phase compound of the invention is a phase having pure spinel structure, and thus more suitable for intercalation. Consequently, known methods of synthesis are not suitable for obtaining the compound of the invention.

The method of the invention is particularly well adapted to obtaining lithium insertion compounds suitable for operating at a voltage greater than 4.5 V relative to Li/Li⁺, in particular those derived by substituting spinel structure lithium manganese dioxide. The insertion compounds obtained by the method have a normal spinel structure and have the following formula:

LiMn_{2-(x+y)}MₓM′_{y}O₄

in which 0<x, 0<y, x+y>0.50, M is Ni or Co, and M′ is selected from Ti, Al, Co, and Mo.

The invention also provides an electrode for a rechargeable lithium electrochemical cell, the electrode containing as its electrochemically active material an insertion compound as described above, and further comprising a binder and a conductive material.

Each electrode is conventionally constituted by a conductive support acting as a current collector and at least one layer containing the active material. The layer is made by depositing a paste on the support, said paste containing the electrochemically active material, a polymer binder, a diluant, and possibly conducive additives. The electrode of the invention preferably contains an electrochemically active material which is the insertion compound described above, a binder, and a conductive material.

The binder may contain one or more of the following compounds: polyvinylidene polyfluoride (PVDF) and its copolymers, polytetrafluoroethylene (PTFE), polyacrylonitrile, polymethyl or polybutyl methacrylate, polyvinyl chloride, polyvinyl formal, amide block polyethers and polyesters, acrylic acid polymers, methacrylic acid, acrylamide, itaconic acid, sulfonic acid, elastomers, and cellulose compounds.

Amongst usable elastomers, mention can be made of terpolymers of ethylene, propylene, and diene (EPDM), copolymers of styrene and butadiene (SBR), copolymers of acrylonitrile and butadiene (NBR), styrene butadiene styrene (SBS) or styrene acrylonitrile styrene (SIS) block copolymers, copolymers of styrene, ethylene, butylene, and styrene (SEBS), terpolymers of styrene, butadiene, and vinylpyridine (SBVR), polyurethanes (PU), neoprenes, polyisobutylenes (PIB), butyl rubbers, etc. and mixtures thereof. The elastomer is preferably a copolymer of butadiene; and more preferably the elastomer is selected from an acrylonitrile butadiene copolymer (NBR) and a styrene butadiene copolymer (SBR). The elastomer content of the binder lies preferably in the range 30% to 70% by weight.

The cellulose compound may be a carboxymethylcellulose (CMC), a hydroxypropylmethylcellulose (HPMC), a hydroxypropylcellulose (HPC), or a hydroxyethylcellulose (HEC). The cellulose compound is preferably a carboxymethylcellulose (CMC). More preferably, the carboxymethylcellulose (CMC) has a mean molecular weight greater than about 200,000. The cellulose compound content of the binder lies preferably in the range 30% to 70% by weight.

For example, the binder may be a mixture of an acrylonitrile butadiene copolymer (NBR) with carboxymethylcellulose (CMC), or a mixture of a styrene butadiene copolymer (SBR) with carboxymethylcellulose (CMC). The elastomer content preferably lies in the range 30% to 70% by weight of the binder and the cellulose compound content preferably lies in the range 30% to 70% by weight of the binder. More preferably, the elastomer content preferably lies in the range 50% to 70% by weight of the binder and the cellulose compound content preferably lies in the range 30% to 50% by weight of the binder.

The method of manufacturing an electrode containing the insertion compound as described above comprises the following steps. The binder is put into the form of a suspension or a solution in a solvent. To form a paste, the active material in powder form is added to the solution or suspension optionally together with manufacturing auxiliaries such as a thickening agent, for example, etc. . . . The viscosity of the paste is adjusted and at least one face of a current collector is coated in the paste in order to form an active layer. The layer is dried and the collector covered in said layer of active material is calendared to obtain the desired porosity, lying in the range 20% to 60% in order to form the electrode.

The current collector is preferably a two-dimensional conductive support, such as a solid or perforated foil, based on carbon or on metal, e.g. copper, aluminum, nickel, steel, stainless steel, or aluminum. A positive electrode preferably comprises a collector made of aluminum while a negative electrode preferably comprises a collector made of copper or of aluminum. Advantageously, the negative collector is made of aluminum. In the event of the storage cell being overdischarged or reversed, this avoids short circuiting by copper dendrites which can happen when the collector is made of copper.

The present invention also provides a rechargeable lithium electrochemical cell having mass and volume energy densities that are improved by using a cathode active material of high discharge voltage and of lower cost than that of presently known materials.

The present invention also provides a rechargeable lithium electrochemical cell comprising at least one positive electrode containing an insertion compound as described above, and at least one negative electrode whose electrochemically active material is a lithium insertion compound selected from a carbon material and a mixed oxide of lithium and of a transition metal. The anode active material may be selected from a carbon material such as graphite, coke, carbon black, and vitreous carbon, and a mixed oxide of lithium and a transition metal such as nickel, cobalt, or titanium. The positive electrode, i.e. cathode during discharging, and the negative electrode, i.e. anode during discharging, are on opposite sides of a separator and they are impregnated in electrolyte.

The electrolyte is constituted by a solution of a conductive lithium salt dissolved in a non-aqueous solvent. The solvent is a solvent or a solvent mixture selected from the usual organic solvents and in particular saturated cyclic carbonates, unsaturated cyclic carbonates, non-cyclic carbonates, alkyl esters such as formiates, acetates, propionates, or butyrates, ethers, lactones such as y-butyrolactone, tetrahydrothiofene dioxide (sold under the trademark “Sulfolane”), nitrile solvents, and mixtures thereof. Amongst saturated cyclic carbonates, particular mention can be made for example of ethylene carbonate (EC), propylene carbonate (PC), butylene carbonate (BC), and mixtures thereof. Amongst unsaturated cyclic carbonates, particular mention can be made for example of vinylene carbonate (VC), its derivatives, and mixtures thereof. Amongst non-cyclic carbonates, particular mention can be made for example of dimethyl carbonate (DMC), diethyl carbonate (DEC), ethyl methyl carbonate (EMC), and mixtures thereof. Amongst alkyl esters, particular mention can be made for example of methyl acetate, ethyl acetate, methyl propionate, ethyl propionate, butyl propionate, methyl butyrate, ethyl butyrate, propyl butyrate, and mixtures thereof. Amongst ethers, particular mention can be made for example of dimethyl ether (DME) or of diethyl ether (DEE), and mixtures thereof.

The conducive lithium salt may be lithium perchlorate LiClO₄, lithium hexafluoroarsenate LiAsF₆, lithium hexafluorophosphate LiPF₆, lithium tetrafluoroborate LiBF₄, lithium trifluoromethanesulfonate LiCF₃SO₃, lithium trifluoromethanesulfonimide LiN(CF₃SO₂)₂ (LiTFSI), lithium trifluoromethanesulfonemethide LiC(CF₃SO₂)₃ (LiTFSM), or lithium bisperfluoroethylsulfonimide LiN(C₂F₅SO₂)₂ (BETI).

The materials commonly used in rechargeable lithium cells are thermally unstable, which raises a severe problem for user safety in unfortunate circumstances. The insertion compound of the present invention presents the advantage of high thermal stability in the charge state while it is in use as the active material in a positive electrode. This positive electrode operates in a high voltage range: 4.5 V to 5.3 V/Li. To provide a cell of improved safety, it must be associated with a negative electrode whose active material is also thermally stable in the same voltage range.

The anode active material is preferably a mixed oxide of lithium and titanium, and more preferably a mixed oxide of lithium and titanium of spinel structure having the general formula Li_{4/3}Ti_{5/3}O₄. More preferably still, the anode active material is a mixed oxide of lithium and titanium of spinel structure having the general formula LiₓTi_{y}O₄ in which 0.8≦x≦1.4 and 1.6≦y≦2.2. In a preferred embodiment, the negative electrode comprises a current collector made of copper or preferably of aluminum, covered in a layer containing the electrochemically active material, a binder, and a conductive material.

Other characteristics and advantages of the present invention appear from the following examples which are naturally given by way of non-limiting illustration, and from the accompanying drawings, in which:

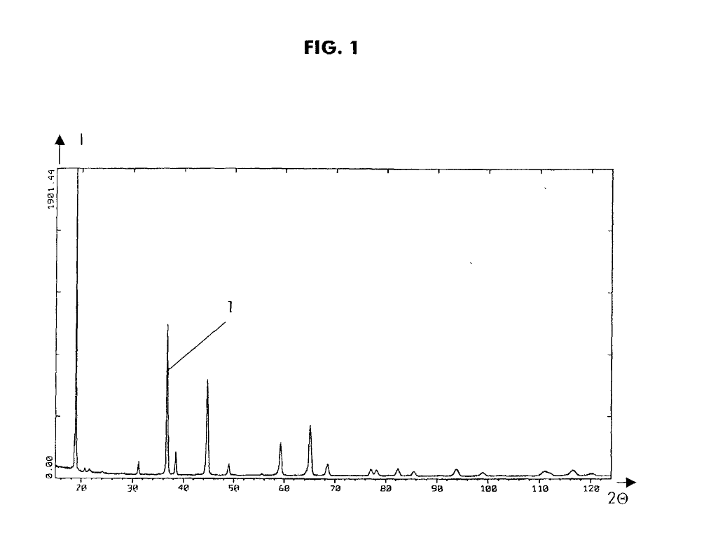

FIG. 1 is an X-ray diffraction pattern of a compound of the invention, with the intensity I of diffraction peaks being plotted up the ordinate axis and with diffraction angle 2Θ being plotted along the abscissa axis;

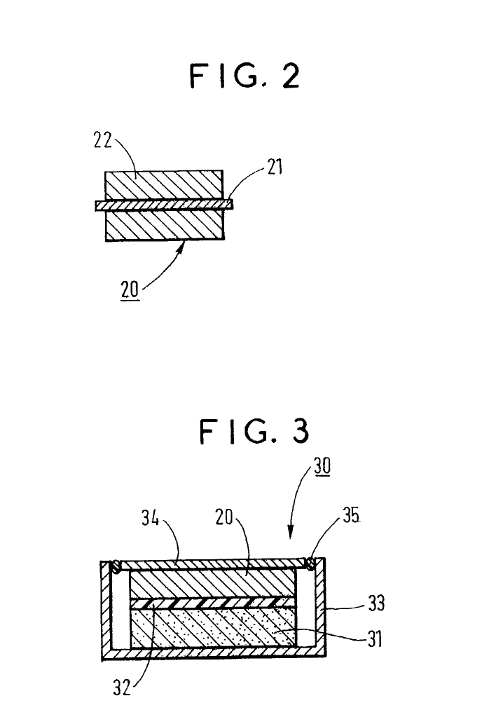

FIG. 2 is a diagrammatic section through an electrode containing the insertion compound of the invention;

FIG. 3 is an exploded diagrammatic section of a button type electrochemical cell containing the electrode of FIG. 2;

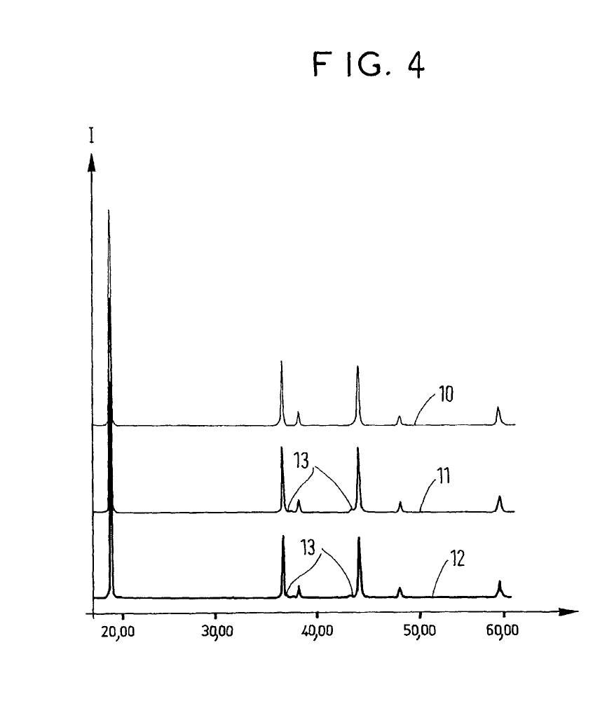

FIG. 4 is a superposition of X-ray diffraction patterns of an insertion compound obtained by the method of the invention and of compounds obtained by other methods, with diffraction peak intensity I being plotted up the ordinate axis with diffraction angle 2Θ being plotted along the abscissa axis;

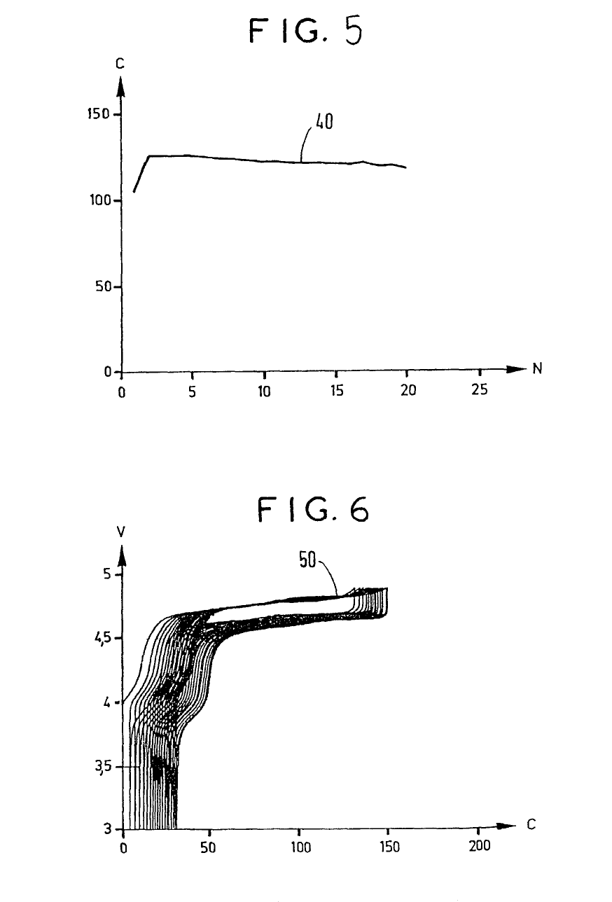

FIG. 5 shows how the capacity of a button type rechargeable electrochemical cell varies over cycling at high potential and at high temperature, the cell having a positive electrode containing an insertion compound obtained by the method of the invention as its active material; capacity C in mAh/g of the active material is plotted up the ordinate axis, and the number of cycles N is plotted along the abscissa axis;

FIG. 6 shows cycling curves relating to the compound of FIG. 5, voltage V relative to Li/Li⁺ is plotted up the ordinate axis, and capacity C in mAh/g of the active material is plotted along the abscissa axis;

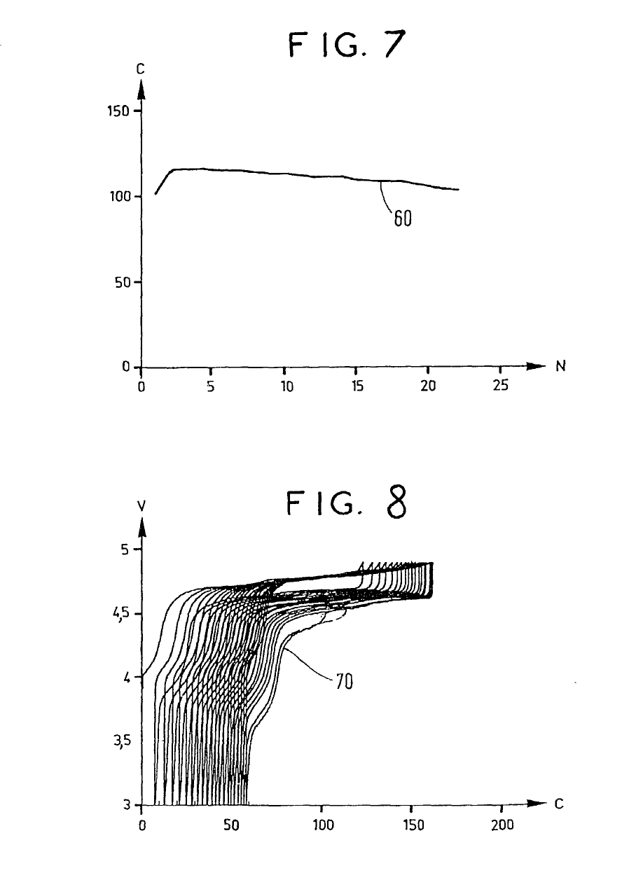

FIG. 7 is analogous to FIG. 5 for a compound obtained by another method;

FIG. 8 is analogous to FIG. 6 for the compound of FIG. 7; and

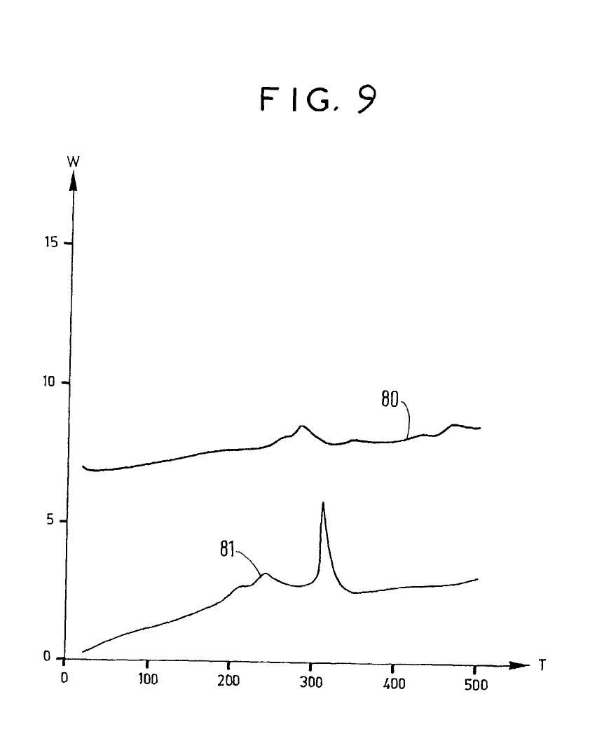

FIG. 9 shows a comparison of differential scanning calorimetry (DSC) diagrams of an electrode having an insertion compound obtained by the method of the invention as its active material and of an electrode containing a compound obtained by another method; heat W in milliwatts per milligram (mw/mg) is plotted up the ordinate axis, and temperature T in ° C. is plotted along the abscissa axis.

### EXAMPLE 1

A lithium insertion compound of the invention was prepared satisfying the following formula LiMn_{0.9}Co_{1.0}Ti_{0.1}O₄ as follows.

An intermediate compound (E)₃O₄ containing no lithium was synthesized by mixing in the desired proportions the oxides Co₃O4, MnO₂, and TiO₂ in fine powder form. This is preferably done using a mechanical mixer. The mixture was heated to 950° C. in air for 24 hours. The resulting solid was finely ground, and heated a second time under the same conditions, and then ground again. This produced a powder whose X-ray diffraction pattern shows that it possesses spinel structure.

The intermediate compound was mixed with lithium carbonate Li₂CO₃ in the proportions 0.50 moles of lithium carbonate per ⅔ moles of intermediate compound. It is preferable to use a mechanical mixer. The mixture was heated to 700° C. under a flow of oxygen for 24 hours. The X-ray diffraction pattern of the insertion compound LiMn_{0.9}Co_{1.0}Ti_{0.1}O₄ obtained in this way is shown in curve 1 of FIG. 1.

In order to be able to evaluate the insertion compound of the invention in electrochemical cycling, an electrode 20 was made as shown in FIG. 2 using the previously prepared LiMn_{1.43}Ni_{0.50}Ti_{0.07}O₄ insertion compound as its active material. The electrode 20 was a two-dimensional aluminum current collector 21 coated in an active layer 22 having the following composition by weight:

| | | |
|---|---|---|
| active material | LiMn_{0.9}Co_{1.0}Ti_{0.1}O₄ | 85% to 92% |
| binder | polyvinylidene | 6% |
| | polyfluoride (PVDF) | |
| conductor | finely divided soot or | 2% to 8% |
| | acetylene black | |

To form the button format electrochemical cell 30 shown in FIG. 3, the electrode 20 was assembled facing a counter electrode 31 of metallic lithium sandwiching a separator 32 comprising a polypropylene fiber layer in the form of a felt sold under the trademark “Viledon” between two microporous layers of polypropylene sold under the trademark “Celgard”. The electrochemical couple obtained in this way was placed in a cup 33 closed in sealed manner by a cover 34 via a gasket 35. It was impregnated with an electrolyte constituted by a mixture of propylene carbonate, ethylene carbonate, and dimethyl carbonate (PC/EC/DMC) in volume proportions 1/1/3, and containing lithium hexafluorophosphate LiPF₆ at a concentration of 1M.

A succession of charges and discharges was applied to the cell in the range 3 V to 5.3 V at ambient temperature with current of 0.05 I_{c}, where I_{c} is the current theoretically required for discharging the cell in 1 hour. The compound of the invention having the formula LiMn_{0.9}Co_{1.0}Ti_{0.1}O₄ possesses high reversible capacity, greater than 100 mAh/g of active material, and this remains very stable with cycling at ambient temperature.

### EXAMPLE 2

A lithium insertion compound was prepared having the following formula LiMn_{1.43}Ni_{0.50}Ti_{0.07}O₄ as follows.

An intermediate compound (E)₃O₄ containing no lithium was synthesized having the formula Ni_{0.75}Mn_{2.15}Ti_{0.10}O₄ by mixing the desired proportions of the following oxides NiO, MnO2, TiO₂ in fine powder form. This is preferably done using a mechanical mixer. The mixture was heated to 950° C. in air for 24 hours. The resulting solid was finely ground, and heated a second time under the same conditions, and then ground again. This produced a powder whose X-ray diffraction pattern shows that it possesses normal spinel structure.

The intermediate compound Ni_{0.75}Mn_{2.15}Ti_{0.10}O₄ was mixed with lithium carbonate Li₂CO₃ in proportions of 0.50 moles of lithium carbonate per ⅔ moles of intermediate compound. It is preferable to use a mechanical mixer. The mixture was heated to 700° C. under a flow of oxygen for 24 hours. The X-ray diffraction pattern of the resulting LiMn_{1.43}Ni_{0.50}Ti_{0.07}O₄ insertion compound is shown in curve 10 of FIG. 4.

In order to be able to evaluate the insertion compound of the invention in electrochemical cycling, an electrode was made analogous to that of Example 1, but using the previously prepared insertion compound LiMn_{1.43}Ni_{0.50}Ti_{0.07}O₄ as the active material. The active layer had the following composition by weight:

| | | |
|---|---|---|
| active material | LiMn_{1.43}Ni_{0.50}Ti_{0.07}O₄ | 85% to 92% |
| binder | polyvinylidene | 6% |
| | polyfluoride (PVDF) | |
| conductor | finely divided soot or | 2% to 8% |
| | acetylene black | |

An electrochemical cell was made in the same manner as in Example 1. The cell was subjected to charging and discharging in the range 3 V to 4.9 V at ambient temperature with current of 0.05 I_{c}, where I_{c} is the current theoretically needed for discharging the cell in 1 hour. Curve 40 of FIG. 5 shows that the compound of the invention having the formula LiMn_{1.43}Ni_{0.50}Ti_{0.07}O₄ possesses high reversible capacity, greater than 130 mAh/g of active material, and remains very stable in cycling at ambient temperature. Some of the cycling curves 50 represented by the plot of FIG. 5 are shown in FIG. 6.

### EXAMPLE 3

By way of comparison, a lithium insertion compound was prepared having the known formula LiMn_{1.50}Ni_{0.50}O₄.

That compound was prepared as in Example 1 by the method of the invention. An intermediate spinel structure compound having no lithium was used having the known formula Ni_{0.75}Mn_{2.25}O₄ (D. G. Wickham, J. Inorg. Nucl. Chem. 1964, Vol. 26, 1369-1377) obtained by either of the following two methods:

co-precipitation of nickel oxalate and manganese, followed by heat treatment in an oxidizing atmosphere at a temperature higher than 800° C.; and

mixing the oxides NiO and MnO₂ at a temperature greater than 1000° C.

The intermediate compound Ni_{0.75}Mn_{2.25}O₄ was mixed with lithium carbonate Li₂CO₃ in proportions of 0.50 moles of lithium carbonate per ⅔ moles of intermediate compound and the method was continued as in Example 1. The X-ray diffraction pattern of the resulting LiMn_{1.50}Ni_{0.50}O₄ insertion compound is given by curve 11 in FIG. 4. Secondary peaks can be observed indicating the presence of a phase 13 of small quantities of “NiO”.

The cell was subjected to a succession of charges and discharges in the range 3 V to 4.9 V at ambient temperature at a current of 0.05 I_{c}, where I_{c} is the current theoretically needed to discharge the cell in 1 hour. Curve 60 in FIG. 7 shows that the prior art compound having the formula LiMn_{1.50}Ni_{0.50}O₄ is not very stable in cycling at ambient temperature. A few of the cycling curves 70 contributing to FIG. 7 are shown in FIG. 8. There can clearly be seen a drift in the charge/discharge curves as cycling continues.

### EXAMPLE 4

In a manner analogous to Example 3, a lithium insertion compound was prepared having the known formula LiMn_{1.50}Ni_{0.50}O₄ except that 0.54 moles of lithium carbonate Li₂CO₃ were mixed with ⅔ moles of intermediate compound Ni_{0.75}Mn_{2.25}O₄. The X-ray diffraction pattern of the resulting insertion compound LiMn_{1.50}Ni_{0.50}O₄ is given by curve 12 in FIG. 4. The presence of a “NiO” phase 13 can likewise be seen.

### EXAMPLE 5

A lithium insertion compound having the formula LiMn_{1.43}Ni_{0.50}Ti_{0.07}O₄ was prepared in the manner described in Example 2.

After two charge/discharge cycles at ambient temperature, the thermal stability of the previously prepared insertion compound was evaluated by the differential scanning calorimetry (DSC) test which is a technique for determining thermal flux variation in a sample subjected to temperature programming. In the present case, the sample was constituted by an electrode impregnated in an electrolyte which was a mixture of propylene carbonate, ethylene carbonate, and dimethyl carbonate (PC/EC/DMC) in volume proportions of 1/1/3, and containing lithium hexafluorophosphate LiPF₆ at a concentration of 1M. The DSC analysis provides information concerning the thermal stability of the electrode and thus of the active material relative to the electrolyte while it is in the charged state.

FIG. 9 shows a curve 80 for the DSC test on an electrode having the insertion compound LiMn_{1.40}Ni_{0.50}Ti_{0.10}O₄ of the invention as its active material in comparison with a curve 81 of an electrode having the known insertion compound of formula LiMn₂O₄ as its active electrode and as used in conventional Li-ion cells operating at about 4 V.

### EXAMPLE 6

A lithium insertion compound of the invention having the formula LiMn_{0.9}Co_{1.0}Mo_{0.10}O₄ was prepared.

The compound was prepared in a manner analogous to Example 1 using the method of the invention. A spinel structure intermediate compound containing no lithium was used that was synthesized from a mixture of MnO₂, Co₃O₄ and MoO₂ in fine powder form. The method proceeded as in Example 1.

Naturally, the invention is not restricted to the embodiments described, but can be varied in numerous ways by the person skilled in the art without departing from the spirit of the invention. In particular, without going beyond the ambit of the invention, it is possible to envisage using a conductive support for the electrode of different kind and structure. Finally, the various ingredients used in making the paste, and the relative proportions thereof can be changed. In particular, it is possible to include additives for making the electrode easier to form, such as a thickening agent or a texture-stabilizing agent, said additives being included in small quantities.

1/ A lithium insertion compound suitable for operating at a voltage greater than 4.5 V relative to Li/Li⁺, derived by substituting spinel structure lithium manganese dioxide, the compound being characterized in that its formula is:
LiMn_{2-(x+y)}MₓM′_{y}O₄
in which 0<x, 0<y, x+y>0.50, M is Co, and M′ is selected from Ti and Mo:

2/ A compound according to claim 1, having the formula: LiMn_{1.0-y}Co_{1.0}M′_{y}O₄ in which 0<y and M′ is selected from Ti and Mo.

3/ A compound according to claim 1, having the formula:
LiMn_{2-(x+y)}CoₓTi_{y}O₄ in which 0<x, 0<y, x+y>0.50.

4/ A compound according to claim 1, having the formula:
LiMn_{1.0-y}Co_{1.0}Ti_{y}O₄ in which 0<y.

5/ A compound according to claim 1, having the formula:
LiMn_{2-(x+y)}CoₓMo_{y}O₄ in which 0<x, 0<y, x+y>0.50.

6/ A compound according to claim 1, having the formula:
LiMn_{1.0-y}Co_{1.0}Mo_{y}O₄ in which 0<y.

7/ A compound according to any preceding claim, in the form of a powder having particles of a size φ such that 1 μm<φ<30 μm.

8/ A compound according to claim 7, in which the particles are of size φ such that 2 μm≦φ≦13 μm with a mean size φₘₑₐₙ=7 μm.

9/ A method of making an insertion compound according to any preceding claim, from a spinel structure intermediate compound of general formula Liᵣ(E)₃O₄ in which r<1 and E designates the set of cations to be introduced into the final material.

10/ A method according to claim 9, in which said intermediate compound is synthesized from a mixture of the oxides of each of said cations.

11/ A method according to claim 9, in which said insertion compound is obtained in a single step from said intermediate compound.

12/ A method according to claim 9, in which said cations are introduced simultaneously.

13/ A method according to claim 9, in which a reaction of lithium diffusion into said intermediate compound is coupled with a reaction of oxidizing said intermediate compound.

14/ A method according to claim 13, in which said reactions are caused to take place by heat treatment at a temperature lying in the range 600° C. to 900° C. at atmospheric pressure.

15/ A method according to claim 9, in which said resulting insertion compound is of normal spinel structure.

16/ An electrode for a rechargeable lithium electro-chemical cell containing as its electrochemically active material an insertion compound according to any one of claims 1 to 8.

17/ An electrode according to claim 16, comprising an aluminum current collector coated in a layer containing said electrochemically active material, a binder, and a conductive material.

18/ A rechargeable lithium electrochemical cell comprising at least one positive electrode containing an insertion compound according to any one of claims 1 to 8, and at least one negative electrode whose electro-chemically active material is a lithium insertion compound selected from a carbon material and a mixed oxide of lithium and a transition metal.

19/ A cell according to claim 18, in which the electro-chemically active material of the negative electrode is a mixed oxide of lithium and titanium having the general formula LiₓTi_{y}O₄ in which 0.8≦x≦1.4 and 1.6≦y≦2.2.

20/ A cell according to claim 19, in which the electro-chemically active material of the negative electrode is a mixed oxide of lithium and titanium having the general formula Li_{4/3}Ti_{5/3}O₄.
